(19) United States
(12) Patent Application Publication
(10) Pub. No.: US 2006/0239470 A1
(43) Pub. Date: Oct. 26, 2006

(54) Support assemblies with rotation adjustment and associated methods

(76) Inventors: Barry Ferrell, Orange, CA (US); Francois Godfrey, Oceanside, CA (US); John Brodie, Huntington Beach, CA (US); Bernie Hawkins, Long Beach, CA (US)

Correspondence Address: PERKINS COIE LLP;PATENT-SEA, P.O. BOX 1247, SEATTLE, WA, 98111-1247, US

(21) Appl. No.: 11/259,429

(22) Filed: Oct. 25, 2005

Related U.S. Application Data
(60) Provisional application No. 60/622,109, filed on Oct. 25, 2004.

(51) Int. Cl. H04R 3/00

(52) U.S. Cl. 381/92

(57) ABSTRACT

A speaker aiming system in accordance with one embodiment includes a speaker portion movable relative to a support portion, and a rotation adjustment device coupled to the speaker portion for rotation of the speaker portion relative to the support portion in first and second directions. The rotation adjustment device has first and second arcuate guides spaced apart from each other and rear rotation guide with first and second portions. The first arcuate guide and the first portion of the rear rotation guide are positioned along a common first arc that defines a first center of rotation. The second arcuate guide and the second portion of the rear rotation guide are positioned along a common second arc that defines a second center of rotation spaced apart from the first center of rotation.

### CROSS REFERENCE TO RELATED APPLICATIONS

This non-provisional patent application claims the benefit of and priority to U.S. Provisional Patent Application No. 60/622,109, entitled Support Assemblies with Rotation Adjustment and Associated Methods, filed Oct. 25, 2004, and which is incorporated herein in its entirety by reference thereto.

### TECHNICAL FIELD

Embodiments of the present invention are directed toward support assemblies with rotation adjustment and associated methods, for example, support assemblies supporting audio and/or visual components.

### BACKGROUND

Audiovisual components often are placed in selected locations for operation and/or storage. In many cases, it is desirable to orient these components in certain directions and/or to adjust the orientation of the components periodically. For example, it is often desirable to orient speakers so that the sound is directed in a selected direction and/or to orient video displays for viewing from selected locations. Orienting these components in a certain direction can be difficult and time consuming, especially when the components are large and/or located in areas with limited space (e.g., when rotating a component that is proximate to a wall).

### BRIEF DESCRIPTION OF THE DRAWINGS

FIG. 1 is an isometric view of a support system with a rotation adjustment device used to support a speaker system in accordance with an embodiment of the invention.

FIG. 2 is an isometric view of the support system shown in FIG. 1 where the speaker system has been rotated to a first side.

FIG. 3 is an isometric view of the support system shown in FIG. 1 where the speaker system has been rotated to a second side.

FIG. 4 is a partially schematic isometric rear view of the support system shown in FIG. 1.

FIG. 5 is partially schematic illustration of the rotation adjustment device of the support system shown in FIG. 1.

FIG. 6 is a close-up view of a portion of the support system shown in FIG. 1.

FIG. 7 is a close-up view of a portion of the support system shown in FIG. 1, shown from different perspective.

### DETAILED DESCRIPTION

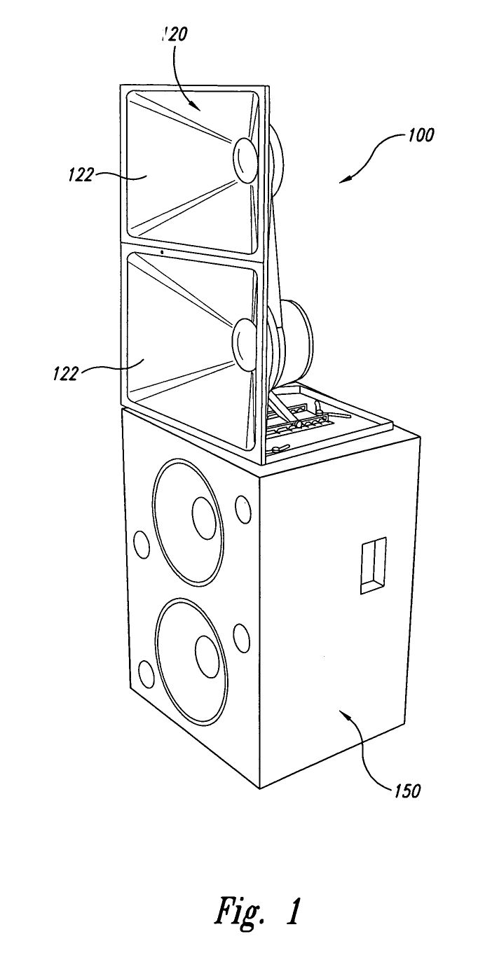

Embodiments of the present invention are directed toward support assemblies with rotation adjustment and associated methods. Several specific details of the invention are set forth in the following description, FIGS. 1-7 to provide a thorough understanding of certain embodiments of the invention. One skilled in the art, however, will understand that the present invention may have additional embodiments, and that other embodiments of the invention may be practiced without several of the specific features described below. For example, the support system assemblies discussed below are discussed with reference to a speaker system and/or other audiovisual components. It will be understood that the support system can be used on any component where having a rotational adjustment is desirable.

For example, FIG. 1 is an illustration of a speaker system 120 supported by a support system 100 in a center facing position, in accordance with certain embodiments of the invention. In the illustrated embodiment, the speaker system 120 (a first speaker system) includes two speakers 122. In other embodiments, the speaker system 120 can include more or fewer speakers 122, and/or the speaker system 120 can be a sub-system (or portion) of a larger speaker system. In other embodiments, the support system 100 can support another type of component (e.g., a display and/or other audiovisual component(s)). In the illustrated embodiment, the support system is positioned on top of a second speaker system 150, and the first speaker system 120 and the second speaker system 150 are both sub-systems of a larger speaker system (e.g., the first speaker system 120 transmits mid and high frequency sound waves and the second speaker system 150 transmits low frequency sound waves). In other embodiments, the support system 100 can be positioned on another surface (e.g., a floor or a surface of another component).

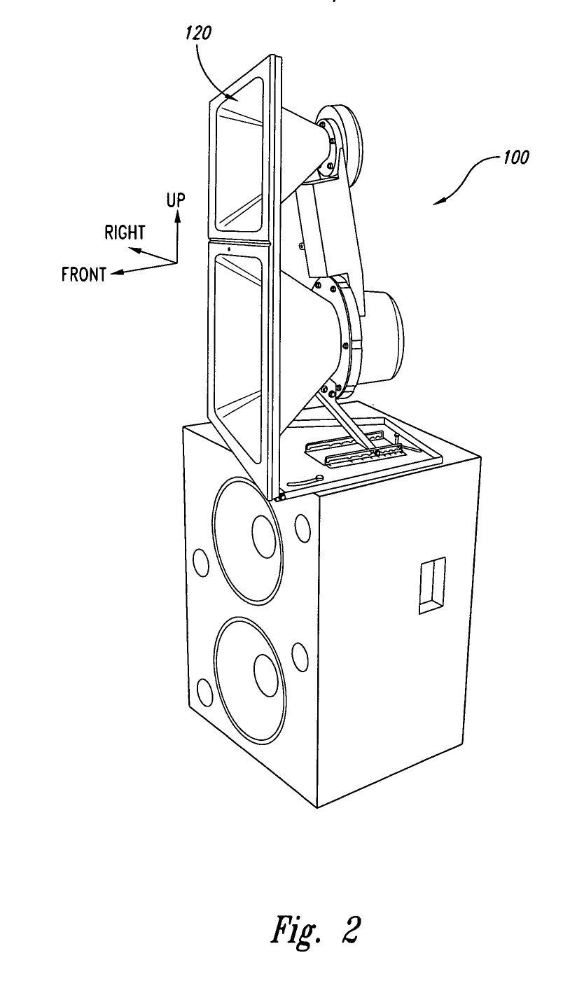

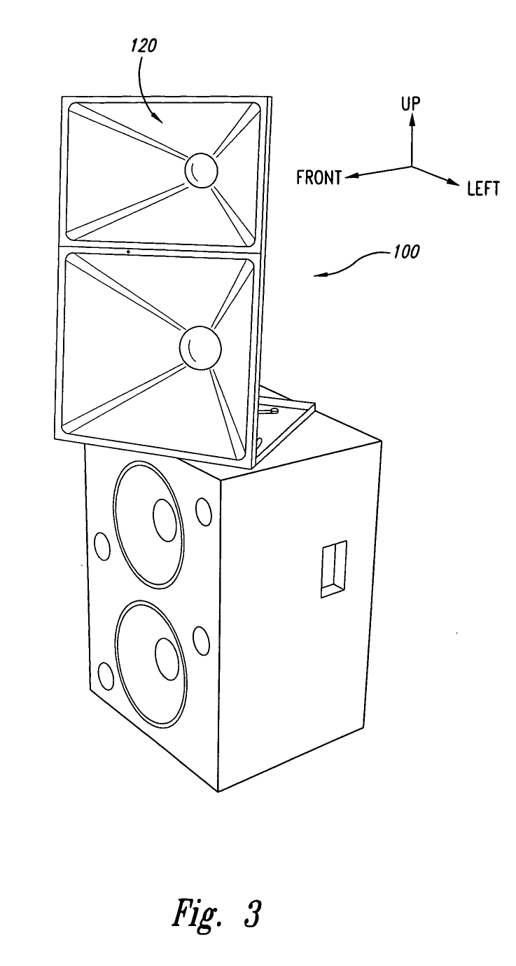

In FIG. 2, the support system 100 is shown rotated to the right, so that the speaker system 120 is aimed or pointed toward the right. In FIG. 3, the support system 100 is shown rotated to the left, so that the speaker system 120 is aimed or pointed toward the left. As shown in FIGS. 2 and 3, the support system 100 rotates the speaker system 120 about a different center of rotation depending on the direction in which the speaker system 120 is rotated away from the center facing position (shown in FIG. 1).

As the speaker system 120 is rotated from the center facing position (shown in FIG. 1) toward a right facing position (shown in FIG. 2), the speaker system 120 is rotated about a center of rotation that is located proximate to the right side of the speaker system 120. Accordingly, the left front corner of the speaker system 120 swings forward and arcs to the right. The right front corner of the speaker system 120 moves a much smaller amount as it moves slightly to the rear. Similarly, as the speaker system 120 is rotated from the center facing position (shown in FIG. 1) toward a left facing position (shown in FIG. 3), the speaker system 120 is rotated about a center of rotation that is located proximate to the left side of the speaker system 120. Accordingly, the right front corner of the speaker system 120 swings forward and arcs to the left. The left front corner of the speaker system 120 moves a much smaller amount as it moves slightly to the rear. This feature can be especially useful when a side of the component carried by the support system 100 is located next to a wall or partition.

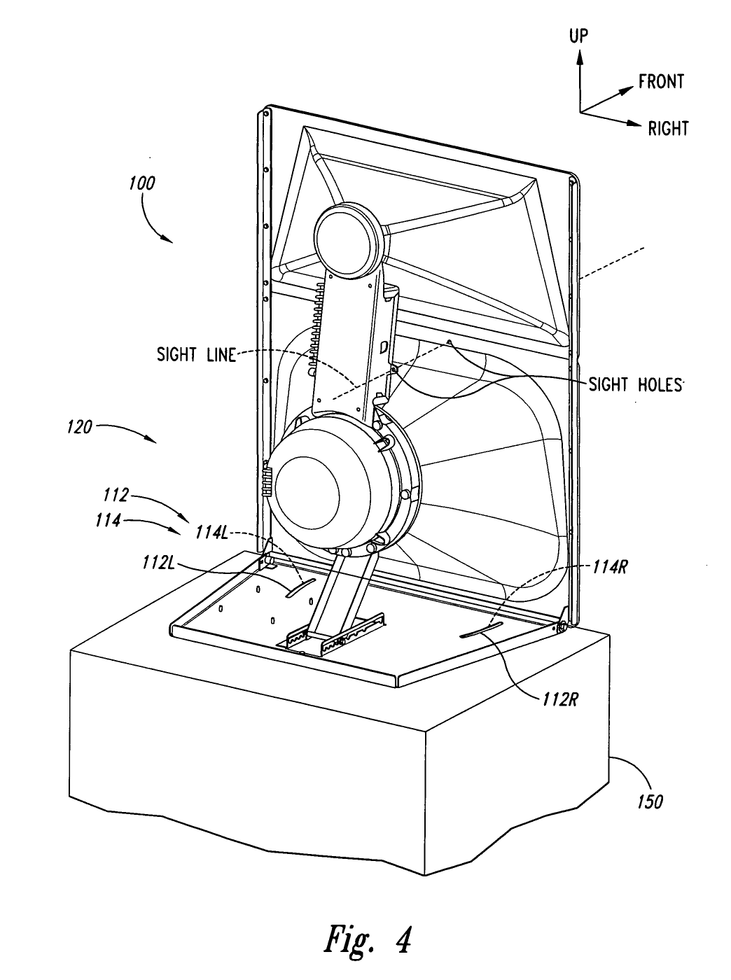

FIG. 4 shows the support system 100, shown in FIG. 1, viewed from the rear. The support system 100 includes a rotation adjustment device 110 having a base 111 and three guides 112 that engage three anchors 114. In the illustrated embodiment, the three guides are shown as a left guide 112L that engages a left anchor 114L, a right guide 112R that engages a right anchor 114R, and a centerline guide 112C that engages a centerline anchor 114C. In the illustrated embodiment, the left anchor 114L and the left guide 112L are in a forward left corner area of the support system 100, and the right anchor 114R and the right guide 112R are in a forward right corner area. The centerline anchor 114C and the centerline guide 112C are located in the rear portion of the support system 100 and located substantially on its centerline. The anchors are fixed to the upper surface of the second speaker system 150 and the guides 112 are slots which engage the anchors. The guides 112 allow the base to move relative to the anchors 114 as the base and first speaker system 120 is rotated to the left or the right.

In other embodiments, the anchors 114 can be coupled to a platform and the base can move relative to the platform. In other embodiments, the anchors 114 can be coupled to other surfaces (e.g., the ground, a surface of another component, or the floor). In certain embodiments, a slippery material can be positioned between a portion of the base 111 and a portion of the surface coupled to the anchors 114 to facilitate movement of the base 111 relative to the surface. In other embodiments, bearings can be used between the base 111 and the surface coupled to the anchors 114 to facilitate movement of the base 111. In still other embodiments, a locking system can be used to lock the support system 100 in certain positions. For example, in one embodiment, the anchors 114 can include bolts that are tightened against the guides 112 once the support system 100 is moved to a selected position. In other embodiments, other locking devices can be used (e.g., a pin that is inserted through the base and the upper surface of the second speaker system 150). In still other embodiments, the support system 100 can include more or fewer guides and/or anchors (e.g., the centerline guide 112C and centerline anchor 114C can be eliminated). In yet other embodiments, different arrangements of guides, anchors, and/or bases can be used. For example, the anchors 114 can include a rolling device coupled to the base 111 and the anchors 114 can roll in guides 112 coupled to the upper surface of the second speaker.

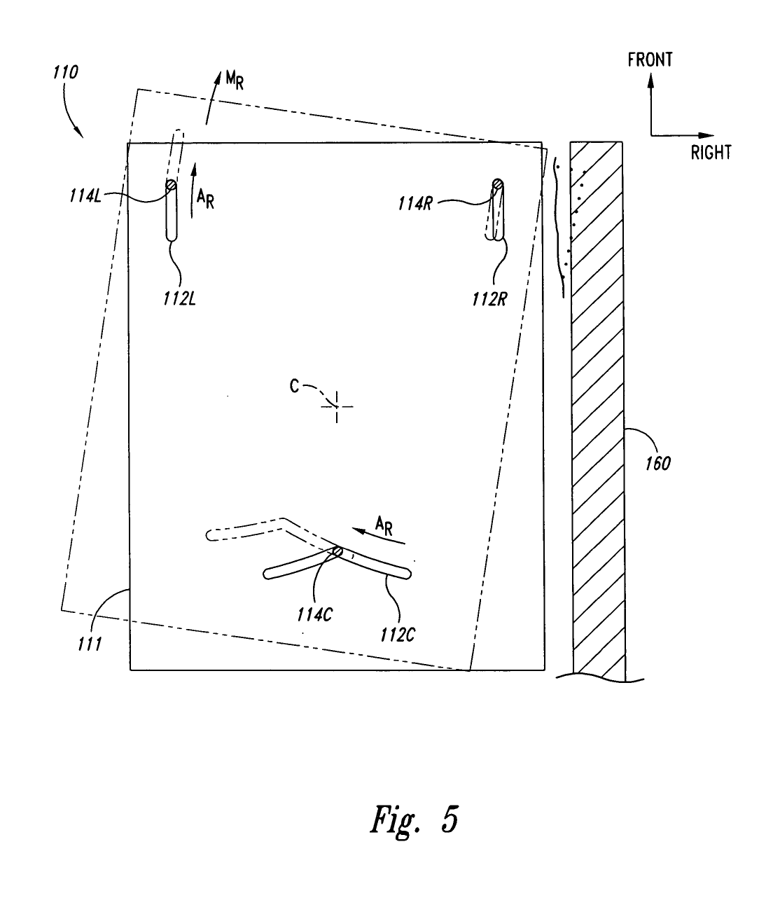

FIG. 5 is a partially schematic illustration of the rotation adjustment device 110 of the support system 100 shown in FIG. 1. The guides 112 are configured to allow movement relative to the anchors 114 when the base 111 is rotated about certain centers of rotation. For example, the left guide 112L and the right portion of the centerline guide 112C are configured to move relative to the left anchor 114L and the centerline anchor 114C (as indicated by arrows/arcs A_{R}) when the right anchor 114R is in the forward portion of the right guide 112R and the base 111 is rotated about the right anchor 114R. Accordingly, solid lines show the base 111 in a forward facing position and dotted lines show the location of the base 111 and the guides 112 after the base and speaker system (shown in FIG. 4) have been rotated to the right as indicated by arrow M_{R}.

When rotating the base 111 from the forward facing position to the right, the right anchor 114R remains in a forward portion of the right guide 112R and defines a first pivot point or center of rotation about which the base 111 rotates. The left guide 112L and the right portion of the centerline guide 112C are configured to allow an arcing movement about this center of rotation. This arcing motion allows the base 111 to move relative to the left and centerline anchors 114L and 114C, respectively, as the base 111 is rotated to the right.

Similarly, when the base 111 is rotated from the forward facing position to the left, the left anchor 114L remains in a forward portion of the left guide 112L and defines a second pivot point or center of rotation about which the base 111 rotates. The right guide 112R and the left portion of the centerline guide 112C are configured to travel in an arcing motion about this second center of rotation. This can allow the base 111 to move relative to the right anchor 114R and the centerline anchor 114C as the base 111 is rotated to the left. When the base 111 is rotated from the right through the center facing position to the left, the base 111 travels through the forward facing position and the center of rotation changes from first center of rotation to the second center of rotation. Similarly, when the base 111 is rotated from the left through the forward facing position to the right, the center of rotation changes from the second center of rotation to the first. Accordingly, the speaker system 120 has dual pivot axes at the corner areas. Other embodiments can have more or fewer centers of rotation and/or the centers of rotation can be located in other areas (e.g., further aft and/or closer to the corners).

A feature of embodiments described above is that the base 111 can have one or more centers of rotation that are not located at the center of the base. This can allow one side of the base 111 to move a substantial amount when the base 111 is rotated, while the other side does not move or moves only a small amount. An advantage of this feature is that the base (and speaker system) can be rotated to the left or right without hitting a wall 160 (e.g., a wall of a building or a wall of a cabinet/entertainment center) located proximate to the sides of the base 111 (as illustrated in FIG. 5) and without the wall blocking the transmission of sound from the speaker system. This is unlike current systems where the speaker is generally rotated about its center. As shown by the dotted line in FIG. 5, if the base 111 were rotated about its center C, the right front corner of the base (shown by the dotted lines) would impact the wall 160 preventing full rotation of the base (and speaker system) and/or causing the wall 160 to interfere with the sound transmission of the speaker. Embodiments of the invention provide similar advantages for other systems. For example, when the support system 100 carries a video display, the display can be rotated without hitting an adjacent wall and without the viewing angle of the display being blocked by the wall.

Another feature of embodiments discussed above is that a component supported by a support system can be quickly and easily rotated to a desired position. Additionally, the component can be securely supported in the selected position. An advantage of this feature is that components can be easily and quickly rotated to selected positions to obtain desired performance (e.g., better viewing angles and/or better sound dispersion).

In other embodiments, the support system 100 can have other arrangements. For example, in certain embodiments the support system 100, shown in FIG. 5, can be configured to rotate in only one direction (e.g., the right guide 112R and right anchor 114R can simply be a fixed pivot point and the base 111 is configured to only rotate to the right). In still other embodiments, the support system can have centers of rotation that work in combination with one another (e.g., as the rotation adjustment device is rotated in a selected direction away from the center facing position, the device rotates about a first center of rotation until reaching a specified point and then rotates about a second center of rotation as the device continues to rotate in the selected direction). In yet other embodiments, the rotation adjustment device can have other arrangements for moving the center of rotation (e.g., pivot points coupled to sliding arms).

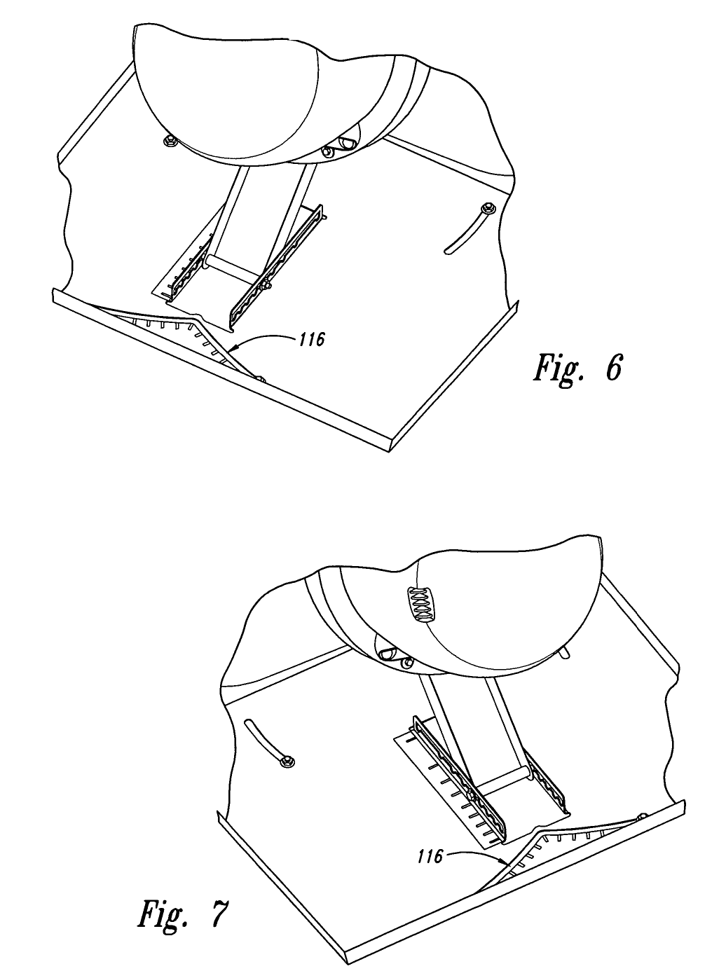

As shown in FIGS. 6 and 7, a scale or index can be provided proximate to and/or on the support system 100 (e.g., next to a guide 112) to provide a reference for selecting various positions. In other embodiments, the scale or index can be included on other portions of the support system 100 or the component carried by the support system 100. In certain embodiments, in addition to the rotation adjustment device discussed above, the support system 100 can also include other adjustment devices (e.g., a tilt adjustment as disclosed in U.S. Provisional Patent Application No. 60/622,153, entitled SUPPORT ASSEMBLIES WITH TILT ADJUSTMENT AND ASSOCIATED METHODS, Attorney Docket No. 29671-8010US, which was filed on Oct. 25, 2004, and which is hereby incorporated by reference herein in its entirety) and/or other devices (e.g., an aiming device for aiming a speaker system similar to the sight holes and sight line shown in FIG. 1 and as disclosed in U.S. patent application Ser. No. 10/973,649, entitled SPEAKER ASSEMBLY WITH AIMING DEVICE, Attorney Docket No. 29671-8009US, which was filed on Oct. 25, 2004, and which is hereby incorporated by reference herein in its entirety).

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Although advantages associated with certain embodiments of the invention have been described in the context of those embodiments, other embodiments may also exhibit such advantages. Additionally, none of the foregoing embodiments need necessarily exhibit such advantages to fall within the scope of the invention. Accordingly, the invention is not limited except as by the appended claims.

I/We claim:

1. A speaker aiming system, comprising:
a speaker portion that is movable relative to a support portion;
a rotation adjustment device coupled to the speaker portion for rotation of the speaker portion relative to the support portion in first and second directions, the rotation adjustment device having first and second arcuate guides spaced apart from each other and rear rotation guide with first and second portions, the first arcuate guide and the first portion of the rear rotation guide being positioned along a common first arc that defines a first center of rotation, and the second arcuate guide and the second portion of the rear rotation guide being positioned along a common second arc that defines a second center of rotation spaced apart from the first center of rotation.

2. The speaker aiming system of claim 1, wherein the rotation adjustment device includes a first anchor positioned in the first arcuate guide, a second anchor positioned in the second arcuate guide, wherein the speaker portion and the first and second arcuate guides move as a unit relative to the first and second anchors as the speaker portion rotates in the first and second directions.

3. The speaker aiming system of claim 1 wherein the rotation adjustment device includes a first member connected to the support portion and slideably disposed in the first arcuate guide, and a second member connected to the support portion and slideably disposed in the second arcuate guide, wherein the speaker portion and the first and second arcuate guides move as a unit relative to the first and second members as the speaker portion rotates in the first and second directions.

4. The speaker aiming system of claim 1, wherein the rotation adjustment device includes indicia coupled to at least one of the first arcuate guide, the second arcuate guide or rear rotation guide and corresponding to the plurality of rotational positions in the first or second directions.
